(19) United States
(12) Patent Application Publication
(10) Pub. No.: US 2012/0184402 A1
(43) Pub. Date: Jul. 19, 2012

(54) Bat With Stiffening Insert

(75) Inventors: Mark McNamee, Portland, OR (US); Steven Alan Jones, Portland, OR (US)

(73) Assignee: Nike, Inc., Beaverton, OR (US)

(21) Appl. No.: 13/006,632

(22) Filed: Jan. 14, 2011

(51) Int. Cl. A63B 59/06; B23P 17/00

(52) U.S. Cl. 473/520; 29/525

(57) ABSTRACT

A tubular bat having a barrel of thin walls is stiffened by rings to adjust and tune performance. The walls of a bat is thinned to reduce weight and to enhance a batters control. However, regulatory bodies dictate performance standards that may require stiffer walls. Additionally different regulatory bodies dictate different standards. Therefore in order to meet regulatory standards in various jurisdictions, the walls of the bat barrel may be stiffened using rings to adjust and tune performance while minimizing the weight of the bat. The design, size and material from which the ring is made may vary. The placement of the ring may be used to tune specific performance profile of a bat.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to a hitting instrument used in sports, and particularly relates to bats such as the kinds used in baseball, softball, wiffle ball and cricket hereinafter referred to simply as “bat” or “bats”. The present invention offers several practical applications in the technical arts, not limited to sports. More particularly, the present invention relates to a method of stiffening a hitting instrument such as a bat to adjust the speed, power, or force with which the ball or other object struck rebounds when it is hit while maximizing the area of least vibration from the impact.

### BACKGROUND OF THE INVENTION

Hitters in sports involving a bat and a ball succeed or fail based upon their ability to hit a ball. The weight, length, material the bat is made of, profile of the bat, and feel of the bat may affect a hitter's control of the bat. Having good bat control affords a player control over the speed, power, or force with which the ball rebounds when it is hit. In a baseball game, a hitter with good control of the bat will be able to hit even difficult pitches. The choice of bat is essential to having good bat control. An athlete looking to have an advantage may seek to use a bat that individually provides better control.

In order to foster fair competition, standards are placed on the equipment used in these sports. Accordingly, organizations such as the National Collegiate Athletes Association (NCAA), Little League Baseball, and Major League Baseball (MLB), etc. regulate the specifications of equipment used in sports that they oversee. These standards may vary from organization to organization. In order for a bat manufacturer's equipment to be acceptable to be used in games that are overseen by these organizations, the equipment must be manufactured to fit the standard specification dictated by the regulator. Examples of specifications dictated by a regulating body includes the types of bats (i.e. wood, metal, or composite), the length of the bat, the weight of the bat, the diameter of the bat, and ball speed, etc.

In recent times metal and composite bats have become popular. Most metal bats are made from aluminum alloys. Both types are hollow inside in an effort to meet weight requirements dictated by the regulatory bodies. These bats may be single-walled, double walled, or multi-walled. Double-walled and multi-walled bats are traditionally lined and the barrel thinned to improve performance due to the walls acting as springs when the ball contacts the barrel. Generally, the thinner the wall of the barrel the greater force with which the ball will rebound, thus improving ball speed and distance. Regulatory bodies have established maximum performance standards for bats based on competition and safety concerns. These standards often limit the performance of a bat to lower levels than those attained by historical bats essentially requiring that the performance curve of the bat be flattened relative to bats previously used. However, not all jurisdictions necessarily have the same standards. As such, a bat manufacturer providing bats for more than one jurisdiction will have to provide bats of multiple specifications, thus incurring additional costs.

Some jurisdictions have begun to regulate Batted Ball Coefficient of Restitution (BBCOR). BBCOR is a measure of how the ball bounces back or the “trampoline effect” from the impact. A pitched ball holds a certain amount of energy. When the ball is hit, it gets additional energy from the bat. However, it may also lose some of the energy from the pitch when it is hit. This loss of energy from the collision is what the BBCOR measures. When a ball is hit be a solid wood bat it is deflected and much of the energy from the pitch is lost. When a ball is hit with a hollow core bat, the deflection is less than if it was hit by a solid wood bat, because the hollow core bat also deflects resulting in less deflection in the ball. Because the deflection of a ball hit by a hollow core bat is smaller, it will retain more of the energy from the pitch. By retaining a higher amount of the energy, and adding the energy from the bat, a ball hit with a hollow core bat has more energy than one hit with a solid wood bat. With less energy loss, the faster the ball speed will be after it is hit by the bat and the further the ball can possibly travel. As such, there are jurisdictions that have regulated performance factors of hollow core bats to be similar to that of the best wood bats.

One method of flattening the performance curve for bats to meet the requirements is to stiffen the walls of the bat. The stiffness of the bat affects the speed, power, or force with which the ball rebounds when it is hit, with a stiffer bat reducing the force with which a ball rebounds from the bat. Bats have been stiffened using a thicker material for the barrel. However, this solution adds weight to the bat, making it slower to swing.

Furthermore, stiffening the entire barrel of the bat decreases the size of the “sweet spot.” The “sweet spot” of a bat is the location on the bat that results in the ball rebounding with the greatest speed when the bat hits a ball. When a ball is hit at the “sweet spot”, the batter feels less vibration from the impact. Therefore, it is desirable to maximize the size of the “sweet spot” of a bat.

Accordingly, it is the object of this invention to provide stiffening for a bat while maximizing performance, meeting safety and weight requirements, and expanding the “sweet spot.”

### BRIEF SUMMARY OF THE INVENTION

The present invention generally relates to a bat used in sports to hit a ball and methods of manufacturing such a bat complies with regulations limiting the force of rebound of a ball without adding excessive weight. A bat in accordance with the present invention may comprise a handle and a hollow barrel portion for striking a ball. The barrel may be single-walled, double walled, or multi-walled. A bat in accordance with the present invention may include one or more rings or disks inserts inserted inside the hollow barrel of the bat to stiffen the barrel without thickening the walls. The ring may be of varying designs and sizes and may be arranged in a manner to maximize the “sweet spot” of the bat. The ring insert may be placed in the “sweet spot.” The ring insert may have minimal weight permitting reduced ball rebound force off of the bat, bringing the bat within performance compliance without rendering the bat excessively heavy. The ring(s) allow the wall of the bat to be potentially even thinner than the wall of previous bats, making a bat in accordance with the present invention lighter and easier to swing. Additionally, manufacturers can make a bat with one basic design but stiffened using different types and/or numbers of inserts to comply with the regulations of particular jurisdictions or the performance of individual athletes or teams. Further, bats with various reduced rebound force levels may be used for training or to level the playing field for various skill levels for competition with athletes of differing skill.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE SEVERAL VIEWS OF THE DRAWING

Examples of the present invention is described in detail below with reference to the attached drawing figures, which are incorporated by reference herein and wherein:

FIG. 1 depicts a cross-section of a basic unstiffened barrel of a bat.

FIG. 2 depicts a cross-section of the basic unstiffened bat barrel deflected upon impact with a ball.

FIG. 3A depicts a bat barrel stiffened by a single ring.

FIG. 3B depicts a cross-section of a bat stiffened by a single ring fitted in a groove machined into the interior surface of the barrel that retains the ring.

FIG. 4 depicts the bat barrel stiffened by a single ring deflected by a load centered over the ring.

FIG. 5 depicts a bat barrel stiffened by a single ring with rib.

FIG. 6 depicts the bat barrel stiffened by a single ring with a rib deflected by a load centered over the ring.

FIG. 7 depicts a bat barrel stiffened by three rings with ribs.

FIG. 8 depicts the bat barrel stiffened by three rings with ribs deflected by a load centered over the middle ring.

FIG. 9 depicts the deflection of a ring with a rib by a load centered between rings.

FIG. 10 depicts the deflection of a ring with a rib by a load centered on the ring.

FIG. 11 depicts the deflection of a donut-shaped insert by a load centered on the ring.

FIG. 12 depicts the deflection of a ring with ribs in a “spokes” design by a load centered on the ring.

FIG. 13 depicts exemplary “spokes” designs for a ring.

FIG. 14 depicts an exemplary “spokes” design for a ring or sleeve.

FIG. 15 depicts an exemplary “A-Split” ring retention option.

FIG. 16A depicts a top view of an exemplary “Spring Snap” retention option.

FIG. 16B depicts a bottom view of an exemplary “Spring Snap” retention option.

FIG. 16C depicts a cross-section of a bat barrel stiffened by a “spring snap” retention ring having multiple “fingers” which snap into machined grooves inside the barrel

FIG. 17A depicts an exemplary perimeter groove ring retention option.

FIG. 17B depicts an exemplary retaining ring.

FIG. 18 depicts a cross-section of a basic barrel with a groove machined into the interior surface of the barrel.

FIG. 19A depicts an exemplary “Spring Finger” retention option.

FIG. 19B depicts a cross-section of a bat barrel stiffened by a “Spring Finger” retention option ring having multiple flanges or “spring fingers” which snap into machined grooves inside the barrel.

FIG. 19C depicts a cross-section of a bat barrel having multiple grooves machined into the interior surface of the barrel that retains an insert.

FIG. 20 depicts an exemplary flowchart of the process of manufacturing a bat which is heat treated before inserting rings.

FIG. 21 depicts an exemplary flowchart of the process of manufacturing a bat which is heat treated after inserting rings.

FIG. 22 depicts an exemplary BBCOR profile of a bat with a thickened wall.

FIG. 23 depicts an exemplary BBCOR profile of a bat with an insert.

### DETAILED DESCRIPTION OF THE INVENTION

The subject matter of examples of the present invention is described with specificity herein to meet statutory requirements. However, the description itself is not intended to limit the scope of this patent. Rather, the inventors have contemplated that the claimed subject matter might also be embodied in other ways, to include different members, portions, and/or elements similar to the ones described in this document, in conjunction with other present or future technologies.

Examples of the present invention relate to a bat stiffened by rings or disks inserted in the barrel of the bat. Different types and/or combinations of rings and/or disks may be used to adjust the performance of the bat to meet regulatory requirements. When added to the bat the inserted ring(s) and/or disks add minimal weight to the bat while tuning performance. Although minimal weights for bats are regulated, it is preferred that most of this weight lies in the handle in order to provide the hitter better control. Thickening the walls of the barrel add weight to the barrel just as adding weighty inserts. Therefore the total weight of the inserts added to the bat should add less than two ounces. Ideally, an added weight from the inserts of less than one ounce would be a preferred. The inserted ring(s) and/or disks may also be arranged to manage stiffness and weight distribution along the bat, which may also be used to expand the “sweet spot.” The current invention allows manufacturers to continue to manufacture bats with a thin barrel wall or shell which is lighter and easier to control. Subtle adjustments in insert design and/or placement may be used to tune specific performance profile of a bat. Multiple inserts of varying sizes or designs may be used to create more specific performance profiles. Thus by using a variety of number of rings, ring designs, ring sizes and lengths, disks, disk designs, and disk sizes, even thinner barrels may be used and the bat may be further fine tuned.

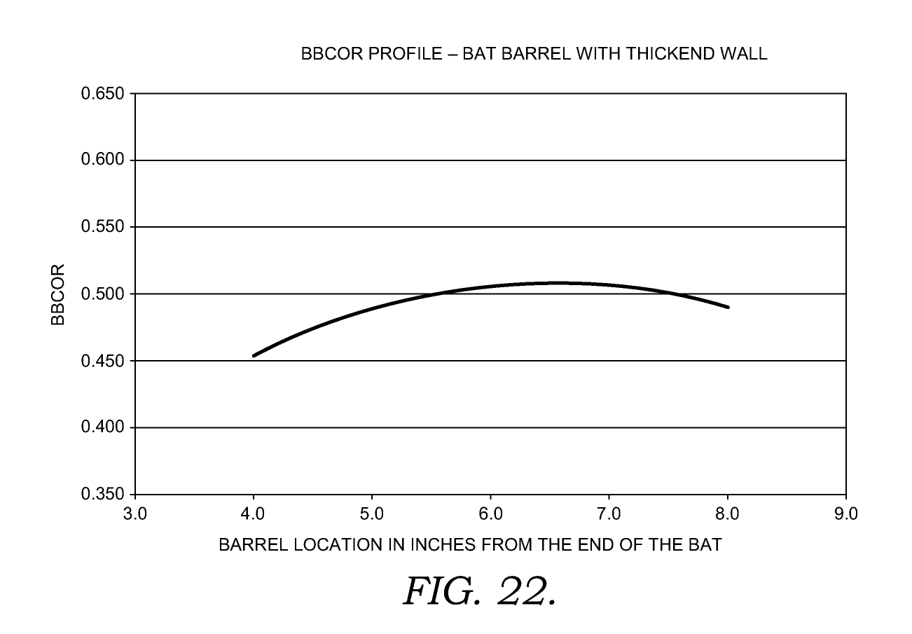

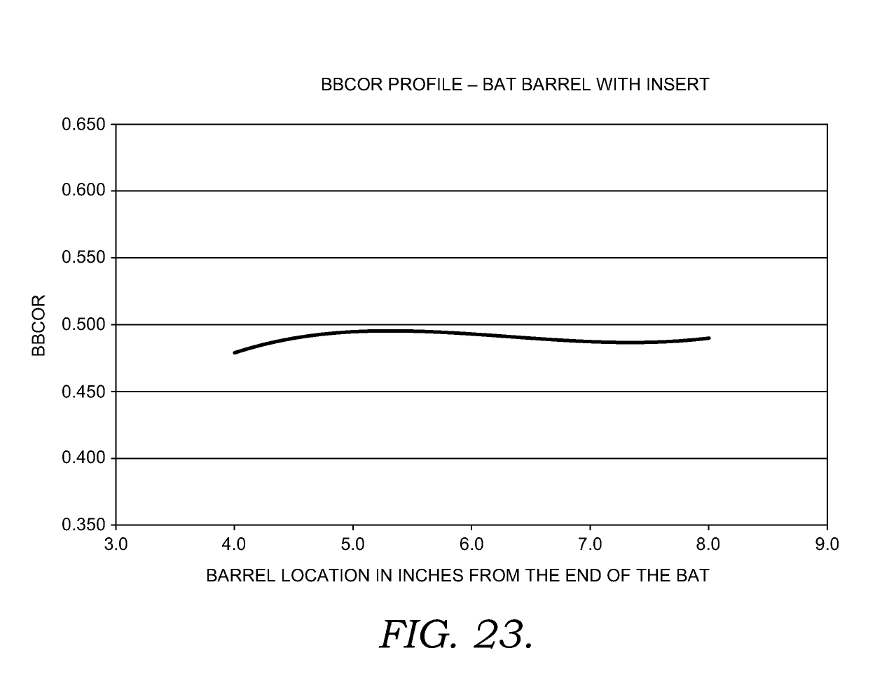

As depicted in FIGS. 22 and 23, the BBCOR of a bat barrel with thickened walls is higher than the BBCOR of a thin walled bat with an insert of the current invention. The highest BBCOR of the bat barrel with thickened wall is above 0.5, while the highest BBCOR of the thin wall bat with an insert is below 0.5. As can also be seen in FIG. 23, the BBCOR on the ends of the profile, for example, at four inches and at eight inches from the end of the bat, are close to that of in the middle of the profile for the thin wall bat with an insert. The range in BBCOR is approximately 0.025 for the thin wall bat with an insert, while the range of BBCOR for the bat with the stiffened wall is approximately 0.07, with the lowest BBCOR occurring at four inches from the end of the bat and the highest BBCOR occurring between 6 and 7 inches from the end of the bat. With the flatter curve depicted in FIG. 23, a larger area of the bat will experience similar performance maximizing the size of the sweet spot.

In one example, the bat and ring may be manufactured and tempered separately with the bat being heat treated before inserting the ring. In another example, the bat and ring may be manufactured and tempered separately and both may be heat treated after inserting the ring.

Inserts for use with a bat in accordance with the present invention may be manufactured from similar aluminum alloys as the bats. However, other materials such as non-aluminum alloys, composites, or nylons may be used to fabricate inserts as well. Materials such as Spring steel, Beryllium-Copper, etc., may provide advantages for assembling a bat due to their properties of contraction and expansion during heating and cooling. Stiff metals such as Titanium or steel may be used for their high characteristic stiffness. High Modulus composites such as Carbon fiber or fiber glass may be used to facilitate the easy placement of an insert at the point desired. Rings made of high modulus plastics such as glass-filled nylon, etc., may be manufactured and placed using injection molding. Rings may be formed by stamping, molding, machining, or any other process.

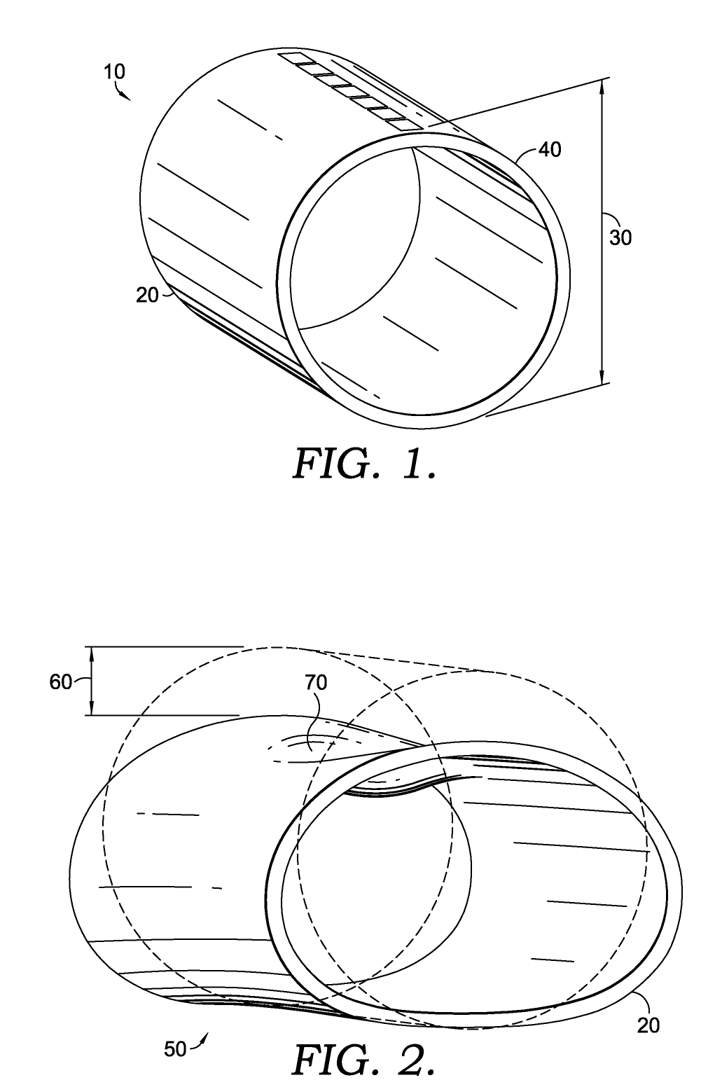

Referring to FIG. 1, a cross-section of a basic unstiffened barrel of a bat is depicted. Unstiffened bat barrel 20 has a diameter 30, for example, 66 mm, to meet regulation. The wall of the barrel or the shell has a thickness 40 to provide optimal performance and durability while also attaining the desired weight of the bat. An exemplary thickness 40 of the shell is 2.84 mm. At rest the bat 10 is fully extended and there is no deflection in the bat.

FIG. 2 shows a cross-section of the basic unstiffened bat 10 barrel 20 deflected upon impact with a ball designated generally as reference numeral 50. Upon impact with a load at impact point 70, the unstiffened bat barrel 20 is deflected by the amount of deflection 60. The amount of deflection is relative to the amount of the load, the thickness of the wall of the barrel, and the material from which the bat is made. For example, an unstiffened aluminum alloy bat with wall thickness 2.84 mm and diameter 66 mm hitting a load of 1000 lbs may be deflected by approximately 0.747 mm, or approximately 0.030 inches.

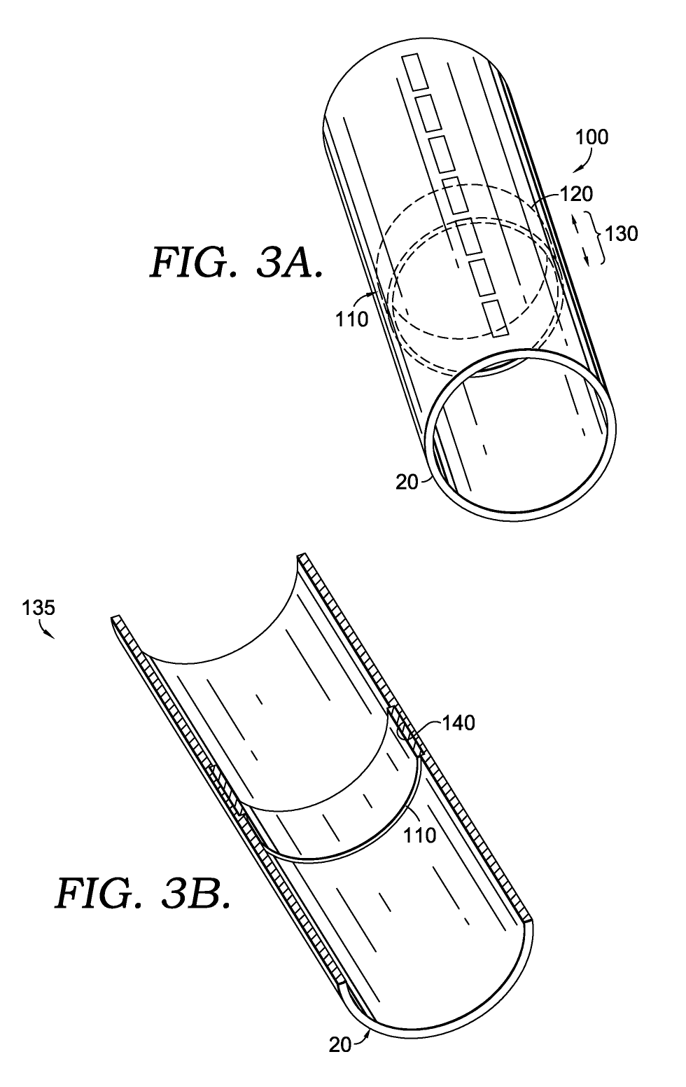

FIG. 3 depicts a cross-section of a bat barrel stiffened by a single ring designated generally as 100. The bat barrel 20 is stiffened by a basic ring 110 of thickness 120 and length 130 and a possessing a certain volume depending on the material from which it is manufactured. For example, the ring may have a volume of 6928.44 cubic millimeters, a thickness 1.5 mm, and a length of 25 mm, and may be manufactured from an aluminum alloy.

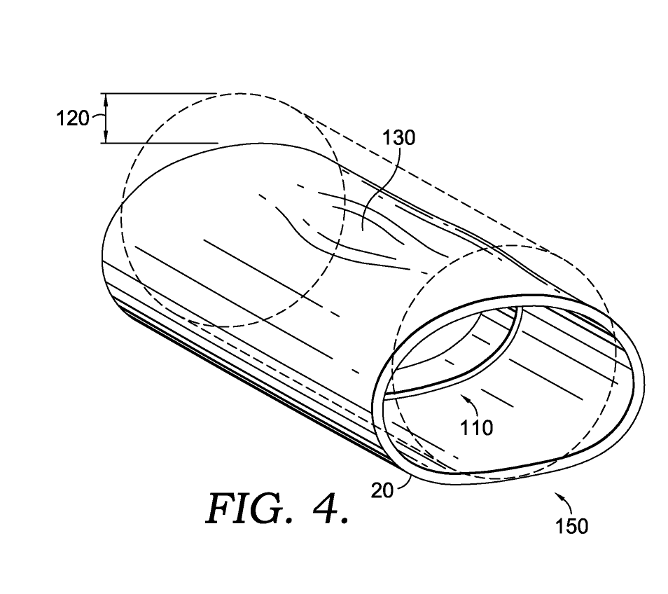

FIG. 4 shows a cross-section of the bat barrel stiffened by a single ring deflected upon impact with a ball designated generally as reference numeral 150. The bat is struck at point of impact 160 which is centered over ring 110. Upon impact, the bat barrel 20 is deflected by the amount of deflection 170. The amount of deflection 170 for the bat stiffened by the single ring is less than the amount of deflection 60 for an unstiffened bat under the same conditions. For example, an unstiffened aluminum alloy bat with wall thickness 2.84 mm and diameter 66 mm hitting a load of 1000 lbs may be deflected by approximately 0.747 mm or approximately 0.030 inches, while the same bat stiffened with a single ring as ring 110 hit at a point of impact over the ring may be deflected by approximately 0.496 mm or 0.020 inches. The thickness of the ring, the material used for the ring, the location of the ring relative to the impact, the design of the ring, and other factors may impact the amount of deflection. Thus stiffening the bat with a similar ring of thickness 2.0 mm which is 25 mm long and possess a volume of 9159.38 cubic millimeters would result in an even lower amount of deflection of approximately 0.42 mm or 0.0165 inches.

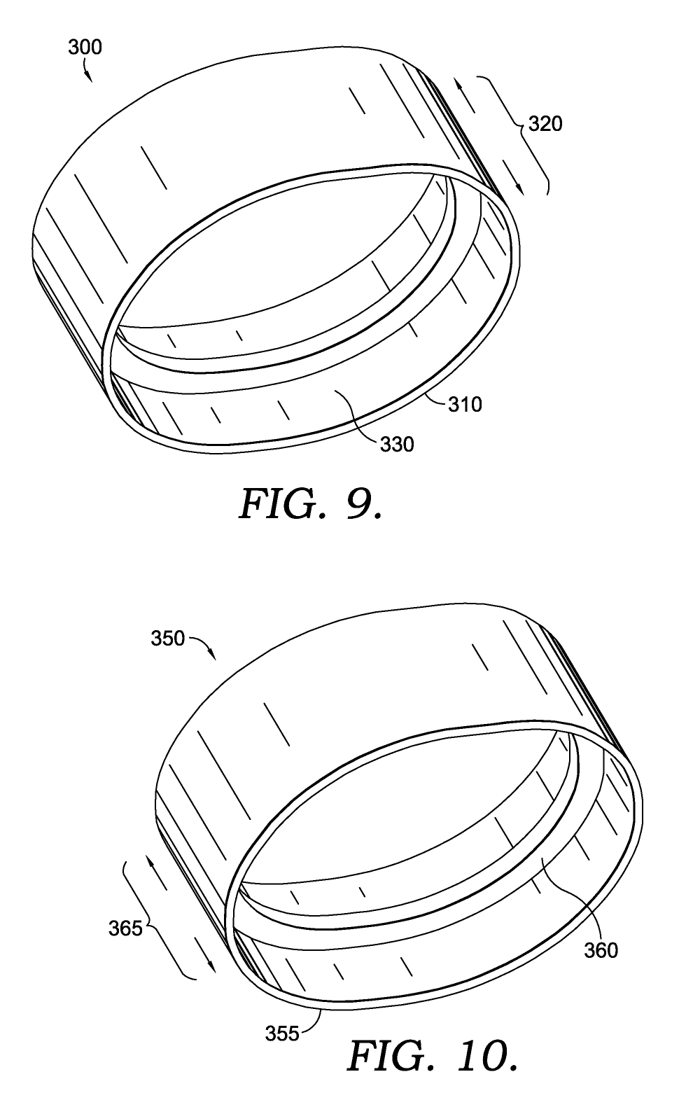

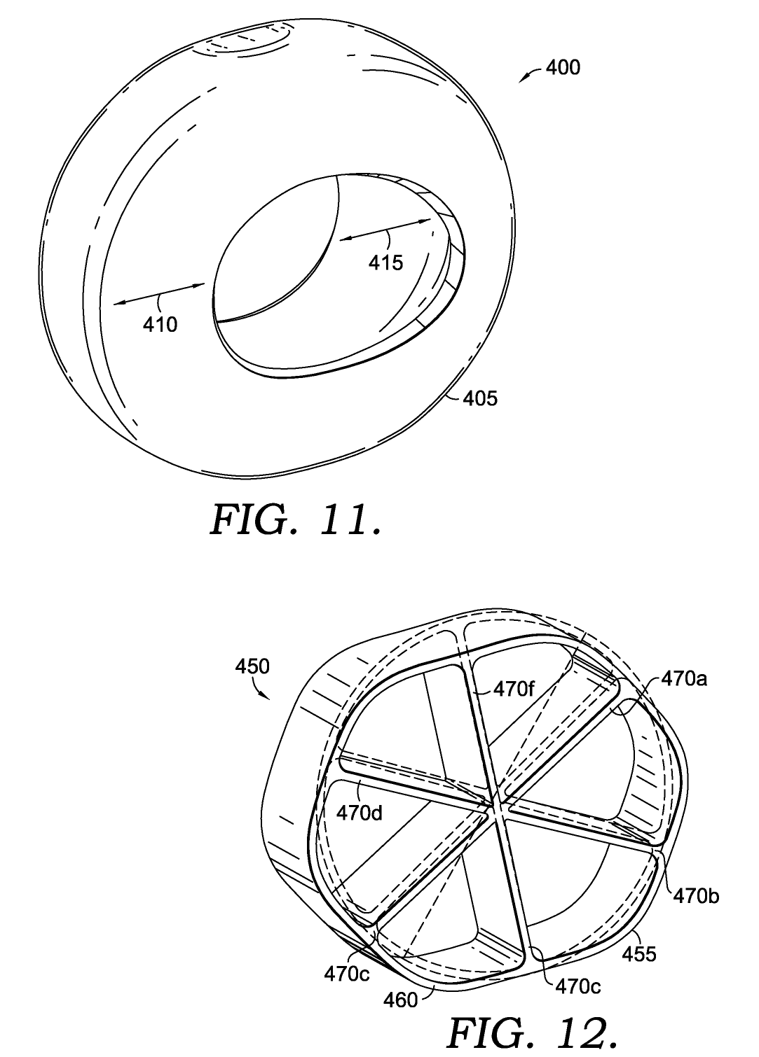

The ring may be manufactured from various materials and in various designs. The composition and design of the ring may also affect the amount of deflection. FIG. 9-14 in general shows various ring designs. Turning now to FIG. 9, the deflection of a ring with a rib is generally depicted as reference number 300. Ring 300 has thickness 310 and is of length 320. Ring 300 also has a rib 330 positioned around the inner circumference midway along the length of the ring. The rib reduces the deflection of the bat more than a similar ring without a rib. A ring with this rib design may be made of aluminum alloy, stainless steel, or any other suitable material. FIG. 10 shows the deflection of a ring similar to the ring of FIG. 9, which is manufactured from an aluminum alloy. The illustration of FIG. 10 is generally depicted as reference numeral 350. Both rings have similar design. FIG. 11 illustrates the deflection of a donut-shaped insert generally depicted as reference numeral 400. This design may also be called a torus or toroid. Ring 405 may be manufactured from nylon or a composite, for example. The ends of the torus act as ribs labeled 410 and 415.

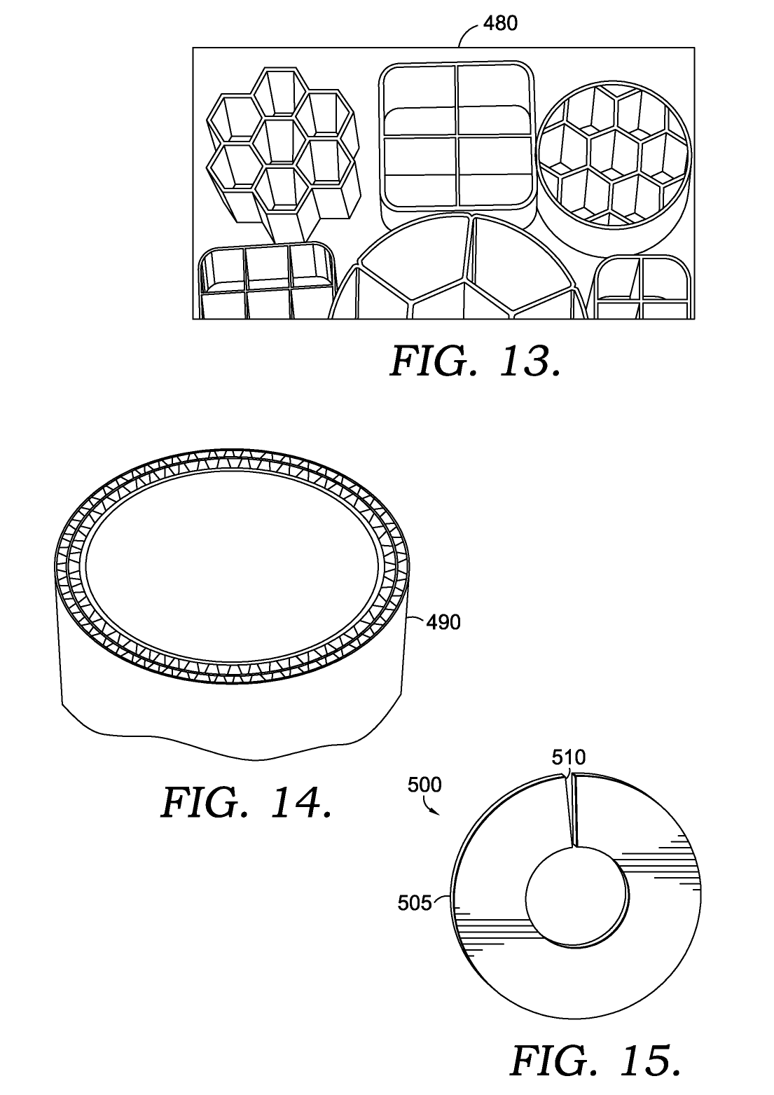

FIG. 12 illustrates a ring with a “spokes” design depicted generally as reference numeral 450. Ring 455 has ribs as “spokes” that extend from the perimeter radially towards the center of the ring. The ring may have numerous “spokes” 470a, 470b, 470c, 470d, 470e, and 470f which meet in the center of the ring. The deflection of a ring in the “spokes” design is less than a comparable simple ring under the same conditions. When compared to the ring 300 both rings being impacted by a load of 200 lbs centered on the ring, ring 300 when hit at a spoke would have deflection of 0.5391 mm or 0.021 inches while ring 450 would have deflection of 0.021 mm or 0.001 inches. The perimeter 460 of the “spokes” ring can be made very thin because the “spokes” add additional stiffening. However, the “spokes” can add weight to the ring. Therefore enough “spokes” are needed to achieve the proper stiffness but not exceed the weight requirement. As discussed above, when the point of impact is on a “spoke” there is very little deflection, however, if the ring is hit between the “spokes” there can be a greater deflection. As such, “spokes” design may be enhanced as shown in FIGS. 13-14. FIGS. 13-14 depict exemplary “spokes”, “honeycomb” and mesh design rings that may provide enhanced coverage and support. Additionally, the ring could be an inner a lining or hollow cylinder.

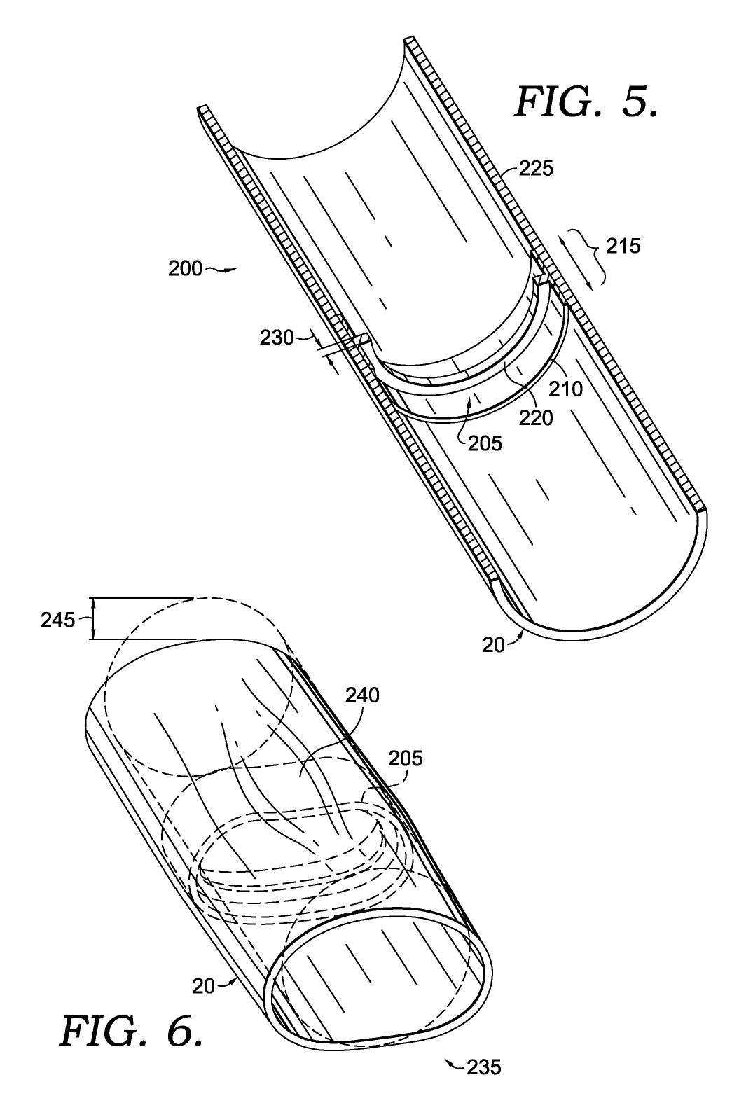

Turning back to FIG. 5, an illustration a cross-section of a bat barrel stiffened by a single ring with a rib is depicted generally as reference number 200. The bat barrel 20 is stiffened by a ring 205 with thickness 210 and length 215. Ring 205 also has a single rib 220 midway along its length which fits around its inner circumference and protrudes inwardly. The rib has a thickness 230 and length 225. FIG. 6 illustrates the deflection of a bat barrel stiffened by a single ring with a rib generally depicted as 235. With ring 205 inserted, bat barrel 20, when hit with a load centered over the ring at point of impact 240 is deflected by amount of deflection 245. With all conditions equal, the amount of deflection experienced by bat barrel 20 stiffened by ring 205 will be less that that experienced when stiffened by ring 110 and even less without any stiffeners.

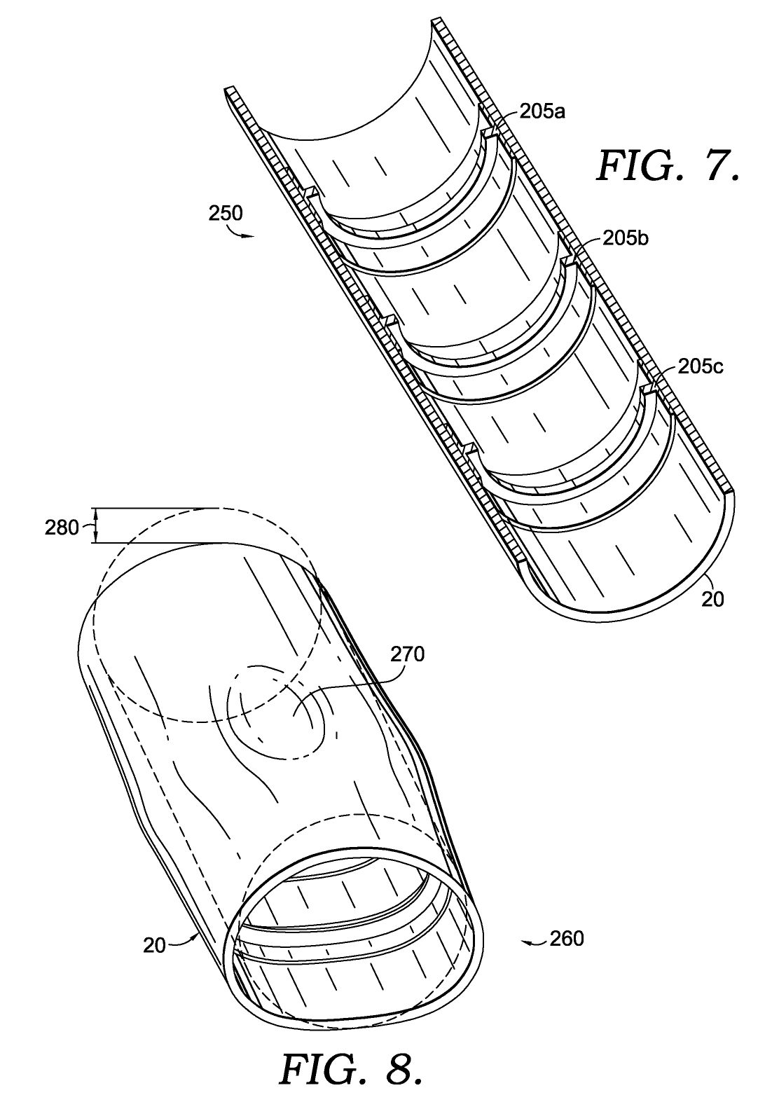

Continuing with FIG. 7, a cross-section of a bat barrel stiffened by three rings with ribs is depicted generally as reference number 250. Bat barrel 20 is stiffened by three rings each with a rib as described above with regards to ring 205. FIG. 8 illustrates the deflection of a bat barrel stiffened by three rings deflected by a load centered over the middle ring with rib. Bat barrel 20 is deflected by amount of deflection 280 when hit at the point of impact 270 by a load centered over the middle ring. The amount of deflection is less for a load centered over the middle ring than for a load centered between the rings.

Bats and rings in accordance with the present invention may be assembled and the rings retained using adhesive bond such as epoxy, PSA, hot glue, etc. Bats and rings in accordance with the present invention may also be press fit possibly aided by heating the barrel and/or chilling the ring(s) as part of the press fitting process. Further, bats and rings in accordance with the present invention may utilize additional retention parts, such as snapping rings that mate with barrel grooves, bonded “stops” before and after a ring, spacers, etc. By way of yet further example, bats and rings in accordance with the present invention may post press or “roll” a bat barrel with a ring(s) in place. FIGS. 3B and 15-19 illustrate some of the aforementioned ring retention options.

FIG. 3B depicts a cross-section of a bat stiffened by a single ring fitted in a groove machined into the interior surface of the barrel that retains the ring generally depicted by reference number 135. Ring 110 is fitted into bat barrel 20 and is snapped into groove 140 which is machined into the interior surface of bat barrel 20 to retain the ring.

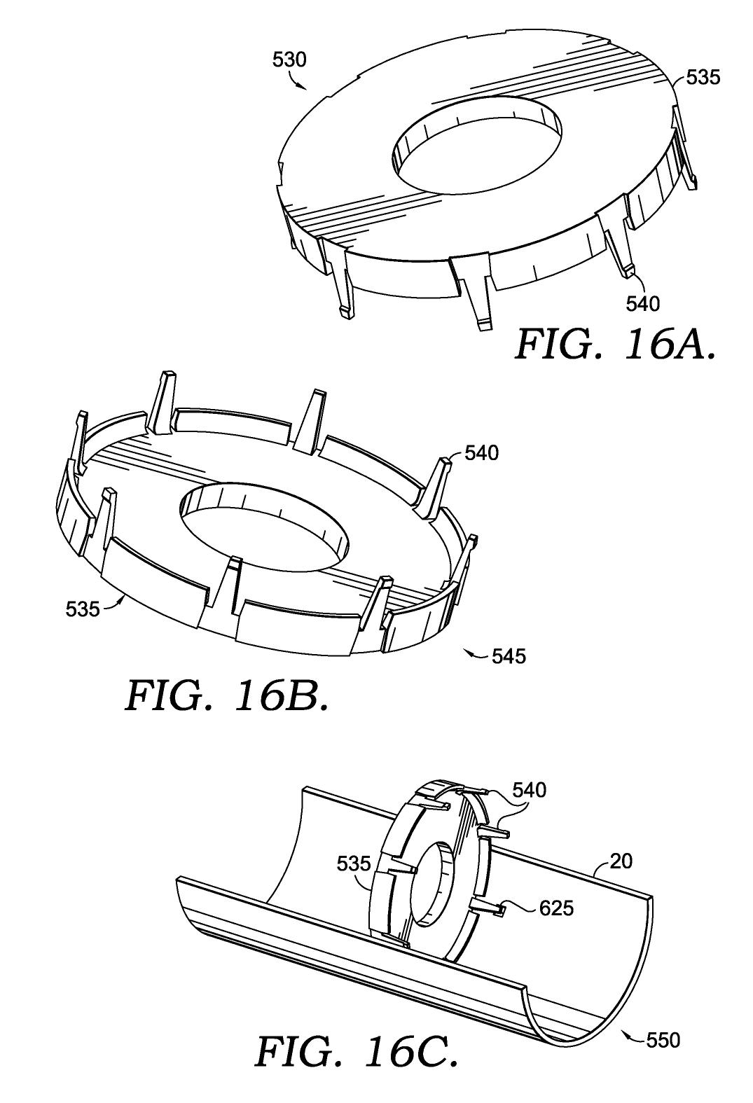

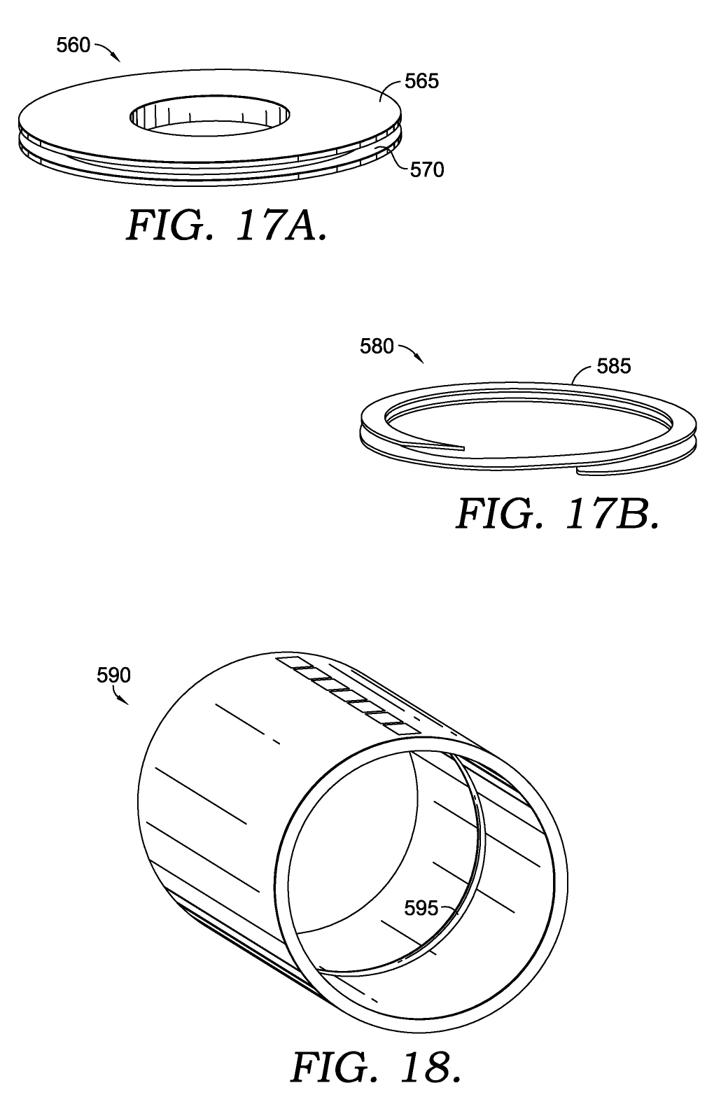

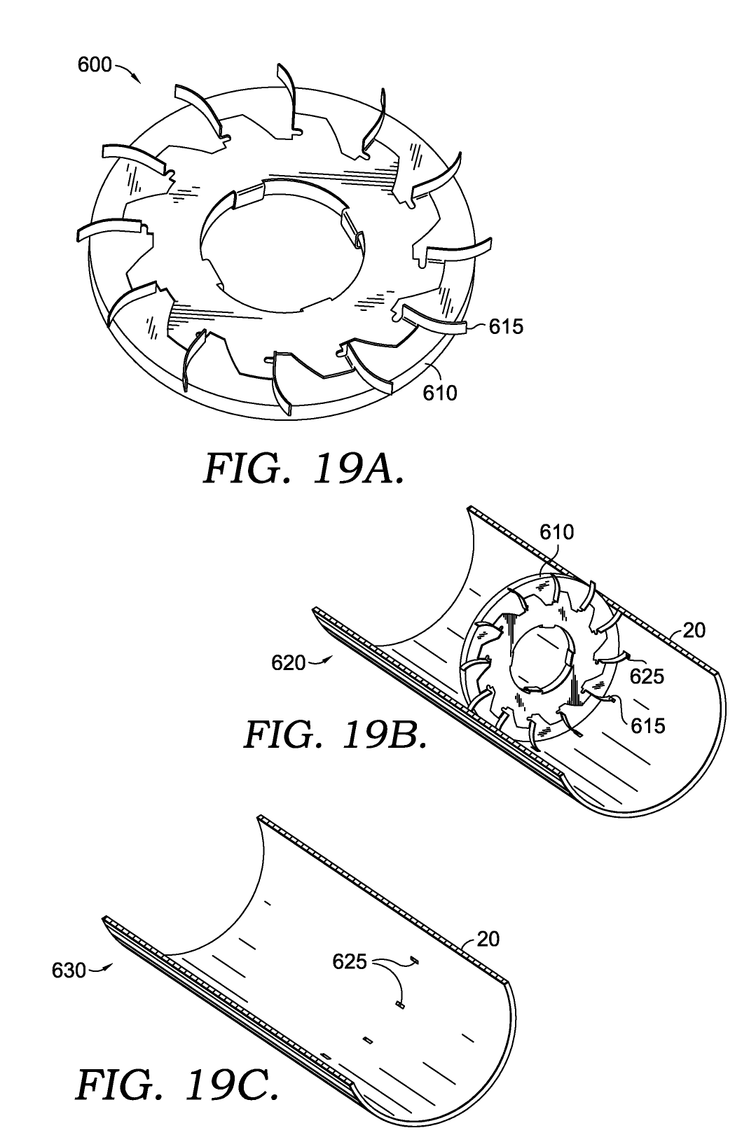

FIG. 15 depicts an A-Split ring retention option generally depicted a reference number 500. Ring 505 may be an exemplary stamped ring with a gap 510 to allow the ring to be compressed and inserted into the bat barrel. Ring 505 may or may not be inserted and retained in a bat barrel similar to that depicted in FIG. 18. FIG. 16A illustrates a first view of a “spring snap” retention option generally depicted as 530, while FIG. 16B illustrates a second view generally depicted as 545. As illustrated in FIGS. 16A and 16B ring 535 may be an exemplary die cast ring which is capable of being pressed into the bat barrel. Ring 535 has multiple “fingers” 540 which snap into machined grooves inside the barrel to hold the ring in place. FIG. 16C depicts generally as reference number 550, a cross-section of a bat barrel 20 stiffened by a “spring snap” 535 retention ring having multiple “fingers” 540 which snap into machined grooves 625 inside the barrel. The bat barrel 20 may be similar to bat barrel 20 depicted in FIG. 19C. FIG. 17A depicts an exemplary perimeter groove ring retention option generally depicted as reference number 560. Ring 565 may be an exemplary machined ring having a perimeter groove 570 to accept a metal retaining ring or high durometer O-ring. The assembly pushes into place and a spring or O-ring sits in a machined groove inside the barrel similar to bat barrel 20 depicted in FIG. 18. FIG. 17B depicts an exemplary retaining ring 585 that may be used with the perimeter groove retention option. This option may also be implemented with an alternating “tooth” version which could be die cast. In FIG. 18 an exemplary cross-section of a basic barrel of a bat to be used with a stiffener is depicted generally as reference number 590. Bat barrel 20 has a groove 595 machined into the interior surface of the barrel that retains an insert. FIG. 19A depicts an alternate example of a spring finger retention option generally depicted as reference number 600. Ring 610 may be an exemplary combination of a stamped load bearing ring combined with a thin formed spring. Ring 610 include multiple flanges or “spring fingers” 615. A twisting motion may be employed to bend the “spring fingers” as the assembly is pushed into the barrel until the “spring fingers” engage a machined groove in the barrel. As such, the flanges or “spring fingers” may be depressed until inserted then expanded to be secured in place. Alternative designs may include injection molded spring part or an insert-molded version where the ring is the insert. FIG. 19B depicts generally as reference number 620, a cross-section of a bat barrel 20 stiffened by a spring finger retention option ring 610 having multiple flanges or “spring fingers” 615 which snap into machined grooves 625 inside the barrel. FIG. 19C depicts an exemplary cross-section of a bat barrel 20 which may be used with an insert such as stiffener 610 having multiple grooves 625 machined into the interior surface of the barrel that retains the insert by engaging the multiple flanges or “spring fingers” 615 which snap into machined grooves 625.

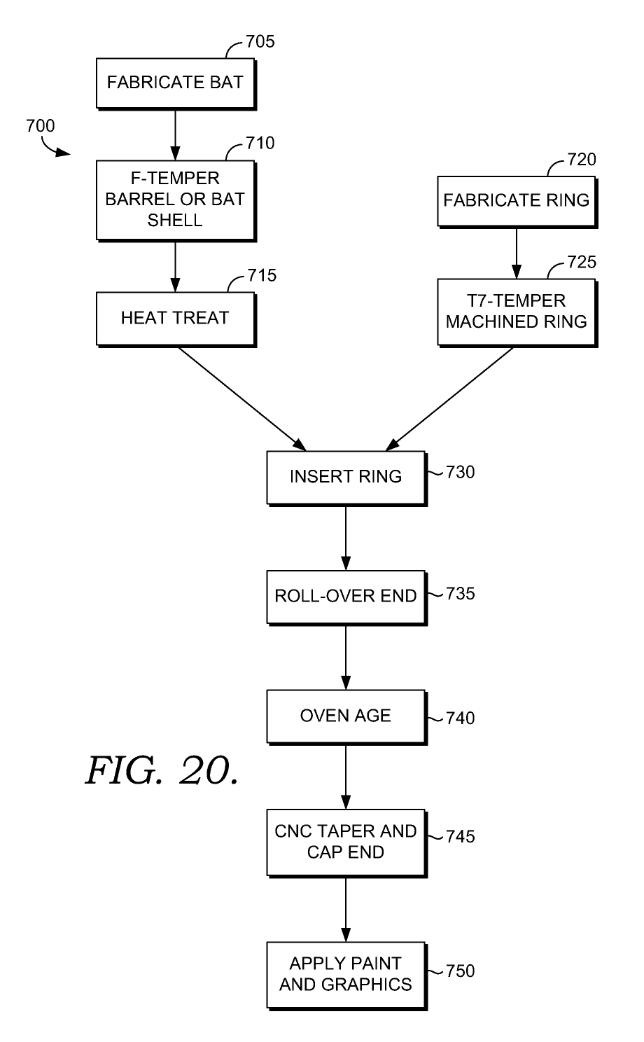

FIG. 20 is exemplary flowchart of the process of manufacturing a bat which is heat treated before adding a ring for stiffening. Beginning at step 705, the bat barrel is fabricated. One or more grooves may be machined into the interior surface of the barrel or shell for engaging one or more inserts. At step 710, the bat barrel or shell is F-Tempered using standard process for constructing a bat without additional stiffening elements. At step 715, the bat barrel is heat treated to produce W-temper conditions and is tempered to comply with specific properties needed. At step 720, a ring may be fabricated to specific dimensions and surface finish. At step 725 the ring may be heat treated and aged to T7 temper. Thus the ring may be solution heat-treated and then stabilized to carry them beyond the point of maximum strength to provide control of some special property. It should be noted that steps 705, 710 and 715 may be performed simultaneously with steps 720 and 725 or at a different time or place. At step 730, the ring is inserted into the barrel. The ring may be press-fitted into the barrel. It should be noted that the ring may be chilled or not treated before inserting into the bat barrel. The ring's center axis is placed parallel to the barrel or the bat's axis and may be positioned at the specified longitudinal location within the barrel or bat. With the bat barrel still in W-temper conditions, at step 735 roll-over operations may be performed. W-temper is an unstable condition therefore with aging the bat barrel will get stronger at room temperature therefore roll-over operation s should be conducted within 4-8 hours of heat treatment while the aluminum is relatively soft and bendable. At step 740, the bat and ring may be oven aged to artificially age the bat and ring to T7-temper using standard practices. The bat and ring may be solution heat treated and aged past the point of peak-strength condition. This process provides control of some special characteristics. At step 745, features such as end groove for cap and taper ID for mating barrel into handle may be machined into the barrel. At step 750 paint and graphics may be applied to the bat.

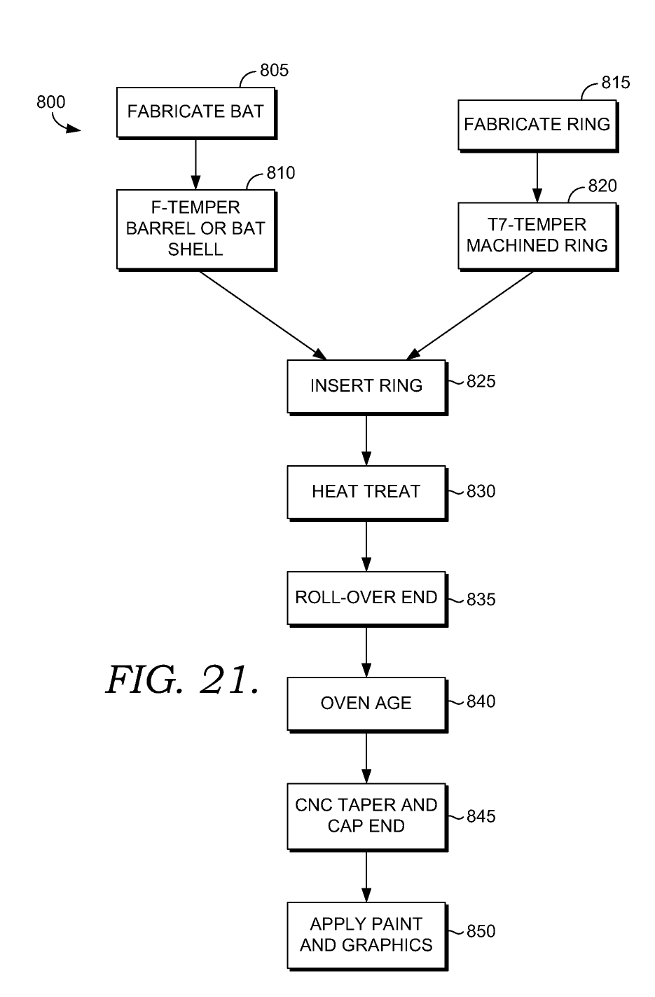

FIG. 21 is exemplary flowchart of the process of manufacturing a bat which is heat treated after adding a ring for stiffening. At step 805 the bat is fabricated. One or more grooves may be machined into the interior surface of the barrel or shell for engaging one or more inserts. At step 810 the bat barrel or shell is F-temper conditions using standard processes. At step 815 the ring is fabricated and is brought to T6 or T7-temper conditions at step 820 using standard processes. Steps 805 and 810 may or may not be performed simultaneously with steps 815 and 820. At step 825 the ring is inserted into the bat barrel as described above. At step 830, the bat and ring are heat treated to produce W-temper condition and at step 835 roll-over operation may be performed. The bat and the ring may be fused together by heat treating them together. At step 840, the bat and ring are artificially age by oven aging to T6 or T7-temper using standard practices. The features are machined into the bat at step 845, then the bat is painted and graphics applied at step 850.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible examples may be made of the invention without departing from the scope thereof, it is to be understood that all matter herein set forth or shown in the accompanying drawings is to be interpreted as illustrative and not in a limiting sense.

The invention claimed is:

1. A tubular bat comprising:
a handle for gripping by a user;
a hollow barrel extending from the handle having a thin wall for impact with a ball, the thin wall minimizing the weight of the bat and deflecting upon impact without breaking or deforming to rebound the ball with a particular amount of speed;
at least one insert of minimal weight inserted and retained in the hollow barrel for stiffening the hollow barrel, wherein the size, design, and the material from which the at least one insert is manufactured determines how much the barrel is deflected and how much the speed of the ball is controlled, the at least one insert retained at a position in the hollow barrel of the bat by press fitting.

2. The tubular bat of claim 1, wherein the at least one insert is a ring with at least one rib.

3. The tubular bat of claim 1, wherein the hollow barrel has at least one groove machined into the interior surface of the barrel that retains the at least one insert.

4. The tubular bat of claim 1, wherein the at least one insert is arranged to expand the area for which the vibration is reduced during impact with the ball.

5. The tubular bat of claim 1, wherein the at least one insert further comprises a plurality of inserts.

6. The tubular bat of claim 5, wherein the plurality of inserts further comprises inserts of different sizes.

7. The tubular bat of claim 5, wherein the plurality of inserts comprises inserts having different designs.

8. The tubular bat of claim 5, wherein the plurality of inserts are manufactured from different materials.

9. The tubular bat of claim 1, wherein the hollow barrel and the at least one insert are made from the same material.

10. The tubular bat of claim 1, wherein the stiffening of the hollow barrel complies with regulatory requirements of a regulatory body.

11. The tubular bat of claim 1, wherein the hollow barrel and the at least one insert are fused together during manufacturing.

12. The tubular bat of claim 1, wherein the at least one insert ring is retained using an adhesive bond.

13. A method for manufacturing a tubular bat, the method comprising:
fabricating the tubular bat shell including a hollow barrel, wherein the wall of the hollow barrel is thinned minimizing the weight of the bat and deflecting upon impact without breaking or deforming to rebound the ball at no more than a required speed;
fabricating at least one insert of minimal weight from a material in a design to a desired size and length;
inserting the at least one insert by press fitting to a position in the hollow barrel, thereby stiffening the hollow barrel to control the speed at which the ball rebounds and to reduce the vibration from the impact, wherein the size, design and the material of the at least one insert determines how much the barrel is deflected and how much the speed of the ball is controlled;
heat treating the hollow barrel and the at least one insert to bond together;
retaining the at least one insert within the hollow barrel to ensure that the at least one insert stay in place.

14. The method of claim 13, wherein the at least one insert ring is retained using an adhesive bond.

15. The method of claim 13, wherein the at least one insert is mechanically retained within the hollow barrel.

16. The method of claim 15, wherein mechanically retaining the insert within the hollow barrel comprise press fitting the insert into the hollow barrel so that at least a portion of the insert mechanically engages a groove machined within the hollow barrel.

17. The method of claim 15, wherein the hollow barrel has one or more grooves machined into the interior surface of the barrel mechanically retaining the at least one insert.

18. The method of claim 13, wherein the hollow barrel is heated before the at least one insert is press-fitted into the hollow barrel.

19. The method of claim 13, wherein the hollow barrel is heated and the at least one insert chilled before the at least one insert is press-fitted into the hollow barrel.

20. The method of claim 13, wherein the at least one insert is chilled before the at least one insert is press-fitted into the hollow barrel.

21. The method of claim 13, wherein the at least one insert further comprises a plurality of inserts.

22. The method of claim 13, wherein the stiffening of the hollow barrel produces regulatory conditions and is adjustable.

23. A method for manufacturing a tubular bat, the method comprising:
fabricating the tubular bat shell including a hollow barrel, wherein the wall of the hollow barrel is thinned minimizing the weight of the bat and deflecting upon impact without breaking or deforming to rebound the ball with a particular amount of speed;
heat treating the hollow barrel;
fabricating at least one insert of minimal weight from a material in a design to a desired size and length;
inserting the at least one insert by press fitting to a position in the hollow barrel stiffening the hollow barrel to produce conditions including controlling the speed at which the ball rebounds and reducing the vibration from the impact, wherein the size, design and the material of the at least one insert determines how much the barrel is deflected and the maximum speed at which the ball rebounds; and
retaining the insert within the hollow barrel to ensure that the one or more rings stay in place.

24. The method of claim 23, wherein the at least one insert ring is retained using an adhesive bond.

25. The method of claim 23, wherein the at least one insert is mechanically retained within the hollow barrel.

26. The method of claim 25, wherein mechanically retaining the insert within the hollow barrel comprise press fitting the insert into the hollow barrel so that at least a portion of the insert mechanically engages a groove machined within the hollow barrel.

27. The method of claim 25, wherein the hollow barrel has one or more grooves machined into the interior surface of the barrel mechanically retaining the at least one insert.

28. The method of claim 23, wherein the hollow barrel is heated before the at least one insert is press-fitted into the hollow barrel.

29. The method of claim 23, wherein the hollow barrel is heated and the at least one insert chilled before the at least one insert is press-fitted into the hollow barrel.

30. The method of claim 23, wherein the at least one insert is chilled before the at least one insert is press-fitted into the hollow barrel.
